(19) United States
(12) Patent Application Publication
(10) Pub. No.: US 2023/0034828 A1
(43) Pub. Date: Feb. 2, 2023

(54) Braided Swim Suit Strap

(71) Applicant: Smacks Swim LLC, Darien, CT (US)

(72) Inventor: Lynne Anderson, Darien, CT (US)

(21) Appl. No.: 17/815,820

(22) Filed: Jul. 28, 2022

Related U.S. Application Data
(60) Provisional application No. 63/226,471, filed on Jul. 28, 2021.

(51) Int. Cl. A41D 7/00; F16G 11/10; D04C 1/06

(52) U.S. Cl. CPC A41D 7/00; D04C 1/06; F16G 11/101

(57) ABSTRACT

A swimsuit customization system including a garment configured to cover at least a portion of a wearer’s torso, having a first side loop and a first top loop on a left lateral side of the garment and a second side loop and a second top loop on a right lateral side of the garment. A strap having a first end and a second end opposite the first end, being removably inserted in the first side loop, the second side loop, the first top loop, and the second top loop. The strap being arranged on the garment defined by the position of the strap in the loops and the order the strap is inserted through the loop. Wherein the first end of the strap is connected to the second end of the strap.

### TECHNICAL FIELD

The present teachings herein generally relate to swimsuits. More particularly, the present disclosure relates to swimsuits with removable and adjustable braided straps that may be worn in various configurations.

### BACKGROUND

Swimsuits are an essential part of all swimmer’s equipment however swimsuits known in the art are not made to fit and are not adjustable. For example, known swimsuits come in standard preset sizes and after an extended period of wearing can cause shoulder tension and chaffing.

Swimsuits available on the market suffer from either being too form fitting causing discomfort after being worn for an extended period of time or being too loose and not secure enough for both recreational and competitive use.

In the case of competitive swimsuits, the straps are always attached to the swimsuit and are not adjustable. The straps are an extension of the swimsuit itself, providing only one way to wear. These swimsuits come is preset sizes and wearers must compromise by using the closest size which may not conform to their specific body type and needs. Competitive swimsuits must be worn for extended periods of time while athletes compete or train. Accordingly, if the swimsuit is too tight then the straps will cause discomfort to the wearer ranging from shoulder tension, skin chaffing, neck aches, and other ailments. Furthermore, the strain on the straps may shorten the lifespan of the swimsuit. Conversely, if the swimsuit is too loose then the swimsuit causes unnecessary drag and risks falling off exposing the wearer.

In the case of recreational swimsuits, the straps are not secure enough to reliably conform the swimsuit to the wearer’s body. These swimsuits sacrifice functionality for comfort and style. Recreational swimsuits offer more adjustability and customizability to the wearer. However, these swimsuits are not as secure and may become loose, particularly as the user moves through the water.

Some swimsuits known in the art have attempted to remedy these disadvantages by using straps that tie together providing adjustable tension. However, these swimsuits are not suitable for competitive use as the straps are not adequately secured together and loose ends provide additional drag. Further these straps are generally tubular so they can be secured together however this shape carries its own disadvantages as described below.

Furthermore, known swimsuit straps in the art are thin and have a generally round shape. This causes them to roll, fold over, or become twisted, adding to a user discomfort as well as creating additional strain, tension, and wear on the straps. Additionally, such swimsuit straps will increase pressure on a narrow area of the wearer.

Additionally, since known swimsuit straps in the art are attached to the swimsuits themselves, when a strap breaks it renders the swimsuit completely inoperable. When a strap breaks the swimsuit must be entirely replaced or the strap is reattached creating a future point of failure.

Swimsuit straps known in the art are often black or the same color as the swimsuit themselves. This causes many swimsuits to be hard to distinguish from one another and makes the wearers of the swimsuits hard to distinguish especially when the wearers have goggles and a swim cap on.

Thus, there is a need for an improved swimsuit. According to the present teachings such a swimsuit may have adjustable and replaceable straps providing user specific fit, comfort, and support while providing even pressure distribution and functionality.

### SUMMARY

The needs set forth herein as well as further and other needs and advantages are addressed by the present embodiments, which illustrate solutions and advantages described below.

It is an object of the present teachings to remedy the above drawbacks and shortcomings associated with known swimsuits in the art.

It is an object of the present teachings to provide a swimsuit with straps that can be worn in a variety of ways and has adjustable tension depending on the wearer’s specific comfort needs and/or preferences.

It is an object of the present teachings to provide a swimsuit with straps that are independent from the swimsuit itself allowing for the straps to be replaced as the straps deteriorate or break, increasing the lifetime of the swimsuit.

It is an object of the present teachings to provide swimsuit straps that are made of a braided composite material that are highly durable and resistant to chemicals used in pools.

It is an object of the present teachings to provide swimsuit straps that are geometrically flat as to evenly distribute tension load over a larger area and prevent twisting of the straps.

It is an object of the present teachings to provide a swimsuit suitable for competitive as well as recreational uses while not sacrificing the benefits described above.

It is an object of the present teachings to provide a swimsuit that is customizable to give wearer’s greater self-expression with various braided swimsuit straps.

It is an object of the present teachings to provide a swimsuit that has straps that may be worn at least three different ways.

It is an object of the present teachings to provide a swimsuit that has straps that may be braided from multiple colors.

The customization of swimsuit straps allows for swimsuits and their wearers to be distinguished from one another for easy identification.

In one embodiment provided is a swimsuit customization system including a garment configured to cover at least a portion of a wearer’s torso. The garment having a first side loop and a first top loop on a left lateral side of the garment and a second side loop and a second top loop on a right lateral side of the garment. The system may also include a strap having a first end and a second end opposite the first end. The strap being removably inserted in the first side loop, the second side loop, the first top loop, and the second top loop. The system my further include an arrangement defined by a position of the strap in the first side loop, the second side loop, the first top loop, and the second top loop and an order of the first side loop, the second side loop, the first top loop, and the second top loop which the strap extends through from the first end to the second end. Wherein the first end is connected to the second end.

In another embodiment provided is a swimsuit customization system including a garment configured to cover at least a portion of a wearer’s torso. The garment having a first side loop and a first top loop on a left lateral side of the garment and a second side loop and a second top loop on a right lateral side of the garment. The system may also include a first strap having a first end and a second end opposite the first end. The first strap being removably inserted in the first top loop and at least one of the first side loop and the second side loop. The system may also include a second strap having a first end and a second end opposite the first end. The second strap being removably inserted in the second top loop and at least one of the first side loop and the second side loop. The system may also include a plurality of arrangements defined by a position of the first strap in the first top loop, the first side loop and the second side loop, a position of the second strap in the second top loop, the first side loop and the second side loop, an order of the first top loop, the first side loop and the second side loop which the first strap extends through from the first end of the first strap to the second end of the first strap and an order of the second top loop, the first side loop and the second side loop which the second strap extends through from the first end of the second strap to the second end of the second strap. Wherein the position of the first strap and the position of the second strap are independent from each other.

Other features and aspects of the present teachings will become apparent from the following detailed description, taken in conjunction with the accompanying drawings, which illustrate by way of example the features in accordance with embodiments of the present teachings. The summary is not intended to limit the scope of the present teachings.

### BRIEF DESCRIPTION OF THE DRAWINGS

FIG. 1 is an illustration of the front of a swimsuit according to the present teachings.

FIG. 2 is an illustration of the back of a swimsuit according to the present teachings.

FIG. 3 is an illustration depicting an alternate strap configuration of a swimsuit according to the present teachings.

FIG. 4 is an illustration depicting an alternate strap configuration of a swimsuit according to the present teachings.

FIGS. 5A-C are schematic diagrams depicting strap configurations according to the present teachings.

### DETAILED DESCRIPTION

The present teachings are described more fully hereinafter with reference to the accompanying drawings, in which the present embodiments are shown. The following description is presented for illustrative purposes only, and the present teachings should not be limited to these embodiments.

The present teachings have been described in language more or less specific as to structural and mechanical features. It is to be understood, however, that the present teachings are not limited to the specific features shown and described, since the device, apparatus, and/or system herein disclosed comprises preferred forms of putting the present teachings into effect.

For purposes of explanation and not limitation, specific details are set forth such as particular structures, architectures, interfaces, techniques, etc. in order to provide a thorough understanding. In other instances, detailed descriptions of well-known devices and/or methods are omitted so as not to obscure the description with unnecessary detail.

Generally, all terms used in the claims are to be interpreted according to their ordinary meaning in the technical field, unless explicitly defined otherwise herein. All references to a/an/the element, apparatus, component, means, step, etc. are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second,” etc. for different features/components of the present disclosure are only intended to distinguish the features/components from other similar features/components and not to impart any order or hierarchy to the features/components.

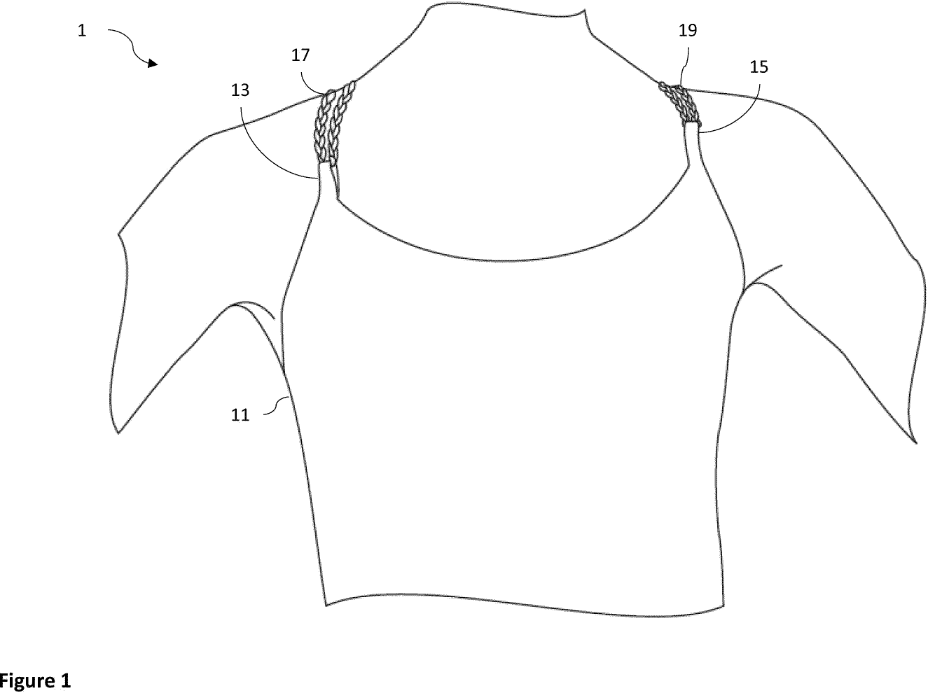

FIG. 1 shows a front view of one embodiment of a swimsuit, more specifically a one-piece adjustable strap swimsuit, according to the present teachings.

The swimsuit 1 may be made of a garment 11. The garment 11 may be a one-piece swimsuit, a swimsuit top, or any other garment capable of covering a portion of the wearer’s torso. The garment 11 may be made of cotton, nylon, polyester, or any other fabric suitable for use as a swimsuit. The garment 11 may be a single continuous piece of clothing or may be multiple pieces secured together. It is understood that the swimsuit 1 may be a one-piece or two-piece swimsuit and the garment 11 may be the entire one-piece swimsuit, two-piece swimsuit, or a portion thereof.

In one embodiment the garment 11 may be one piece swimsuit covering substantially all of the wearer’s anterior torso including the wearer’s breasts, stomach, genitalia, and buttock.

The swimsuit 1 may also have a first top loop 13 and a second top loop 15. The top loops 13, 15 may be attached to the garment 11. The first top loop 13 may be on a right chest section of the garment 11. The first top loop 13 may be above the right breast and below the right shoulder of the wearer. The second top loop 15 may be on a left chest section of the garment 11 opposite the first top loop 13. The second top loop 15 may be above the left breast and below the left shoulder of the wearer. The top loops 13, 15 may be made of the same material as the garment 11 or a different material and may be an edge seam of increased thickness and may contain stitching for increased support and durability. It is understood that the swimsuit 1 may have additional top loops as necessary. For example, the swimsuit 1 may include two pairs of adjacent top loops for increased support and durability.

The swimsuit 1 may also have a first strap 17 and a second strap 19. The straps 17, 19 may be made of natural rubber, synthetic rubber, latex, nylon, stretch fabric (elastomerics), blended rubber with polyester, blended rubber with cotton, blended rubber with nylon or any combination thereof and may be covered in woven or nonwoven material, cotton, polyester, nylon, poly-vinyl chloride (PVC), rayon, microfiber, acrylic, acetate, wool, leather, vinyl, or any other suitable fabric that is able to withstand wear and tear and repeated stretching and contracting over time. The first strap 17 may pass through first top loop 13 and may be threaded through the first top loop 13 providing dynamic adjustability depending on the wearer’s movement and comfort needs. The second strap 19 may pass through second top loop 15 and may be threaded through the second top loop 15 providing dynamic adjustability depending on the wearer’s movement and comfort needs. The top loops 13, 15 may be sized such that the straps 17, 19 are slidable through the open space of the top loops 13, 15 both when worn and not worn.

In one embodiment the straps 17, 19 may be made of a plurality of bands braided together. In a preferred embodiment each strap 17, 19 may be made of three bands braided together. The plurality of bands may be made of the same or different materials as each other and may be made of natural rubber, synthetic rubber, latex, nylon, stretch fabric (elastomerics), blended rubber with polyester, blended rubber with cotton, blended rubber with nylon or any combination thereof and may be covered in woven or nonwoven material, cotton, polyester, nylon, poly-vinyl chloride (PVC), rayon, microfiber, acrylic, acetate, wool, leather, vinyl, or any other suitable fabric that is able to withstand wear and tear and repeated stretching and contracting over time. In a preferred embodiment the plurality of bands may be a geometrically flat shape and braided to form the straps 17, 19 having a geometrically flat shape. In a further preferred embodiment, the plurality of bands may come in variety of colors and/or patterns. The plurality of bands, when braided together, may be a unique combination of colors and patterns allowing for the straps 17, 19 to be used to identify the swimsuit 1 and the wearer. The plurality of bands may be further imprinted with additional identifiers such as letters, numbers, shapes, images, or other characters.

The straps 17, 19 my expand and contract while worn. The material of the straps 17, 19 may be elastic (e.g., nylon, PVC, etc.), expanding and contracting with the wearer’s movement. For example, while swimming the elastic material of the straps 17, 19 may expand and contract such that the swimsuit 1 is form fitting to the user while distributing tension over the entire length of the straps 17, 19.

In one embodiment the braided structure of the straps 17, 19 may allow the strap to expand and contract. The braided lattice-like structure may move such that the length of the of the straps 17, 19 contracts and the width of the straps 17, 19 expands. Inversely the length of the of the straps 17, 19 may expand and the width of the straps 17, 19 may contract. Even when the material used for the straps 17, 19 is not elastic the straps 17, 19 may still expand and contract due to the braided structure.

In a preferred embodiment the straps 17, 19 may be made of an elastic material and have a braided structure. The combination of the elastic material and braided structure may provide increased adjustability in the straps 17, 19 and provide wearer’s greater comfort without sacrificing the form fitting necessity of competitive swimsuits.

The geometrically flat shape of the straps 17, 19 may evenly distribute tension from the straps 17, 19 on the wearer. As the straps 17, 19 expand and contract the tension and movement of the straps 17, 19 may be distributed over the entire width of the strap 17, 19. The geometrically flat shape of the straps 17, 19 may prevent chafing, particularly as compared to tubular straps which concentrate the tension in a smaller area. The braided structure may increase the width of the straps 17, 19 thereby providing a greater area to distribute tension in the straps 17, 19.

It is understood that the straps 17, 19 may be made of a single band or any number of bands as necessary to achieve a desired thickness, width, durability, tensile strength, or other desired properties as described above or herein.

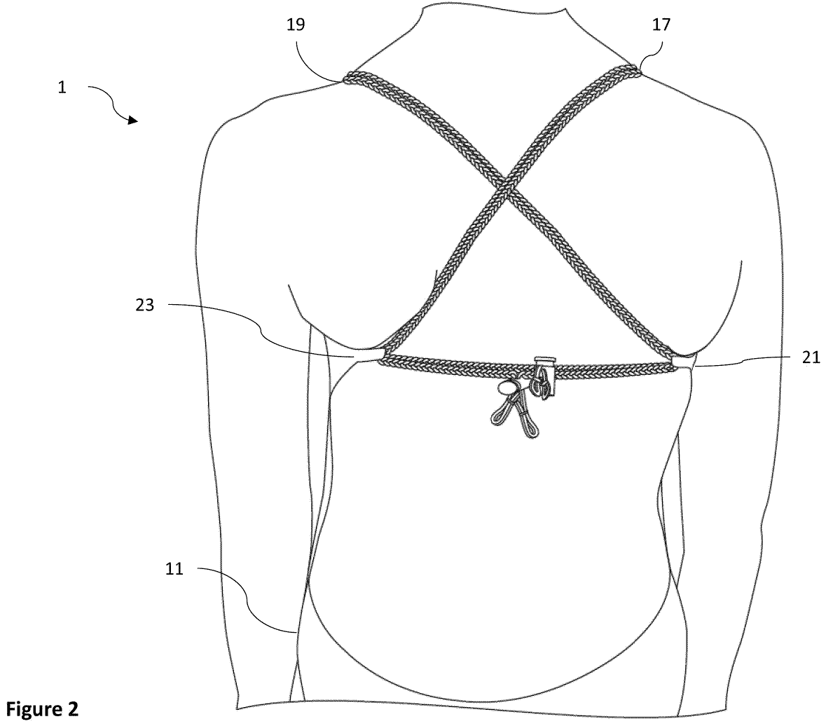

FIG. 2 shows a back view of one embodiment of a swimsuit, more specifically the back view of the swimsuit shown in FIG. 1, according to the present teachings.

The swimsuit 1 may also have a first side loop 21 and a second side loop 23. The side loops 21, 23 may be attached to the garment 11. The first side loop 21 may be on the lateral side of the right chest section of the garment 11. The first side loop 21 may be below the right armpit of the wearer and/or may stretch to be below the right shoulder blade of the wearer. The second side loop 23 may be on the lateral side of the left chest section of the garment 11 opposite the first side loop 23. The second side loop 23 may be below the left armpit of the wearer and/or below the left shoulder blade of the wearer. The side loops 21, 23 may be made of the same material as the garment 11 or the top loops 13, 15 or a different material and may be an edge seam of increased thickness and may contain stitching for increased support and durability. It is understood that the swimsuit 1 may have additional side loops as necessary. For example, the swimsuit 1 may include two pairs of adjacent side loops for increased support and durability.

Each end of the first strap 17 may pass through at least one of first side loop 21 and/or the second side loop 23 and may be threaded through the first side loop 21 and/or second side loop 23 providing dynamic adjustability depending on the wearer’s movement and comfort needs. Each end of the second strap 19 may pass through at least one of first side loop 21 and/or the second side loop 23 and may be threaded through the first side loop 21 and/or second side loop 23 providing dynamic adjustability depending on the wearer’s movement and comfort needs. The side loops 21, 23 may be sized such that the straps 17, 19 are slidable through the side loops 21, 23 both when worn and not worn.

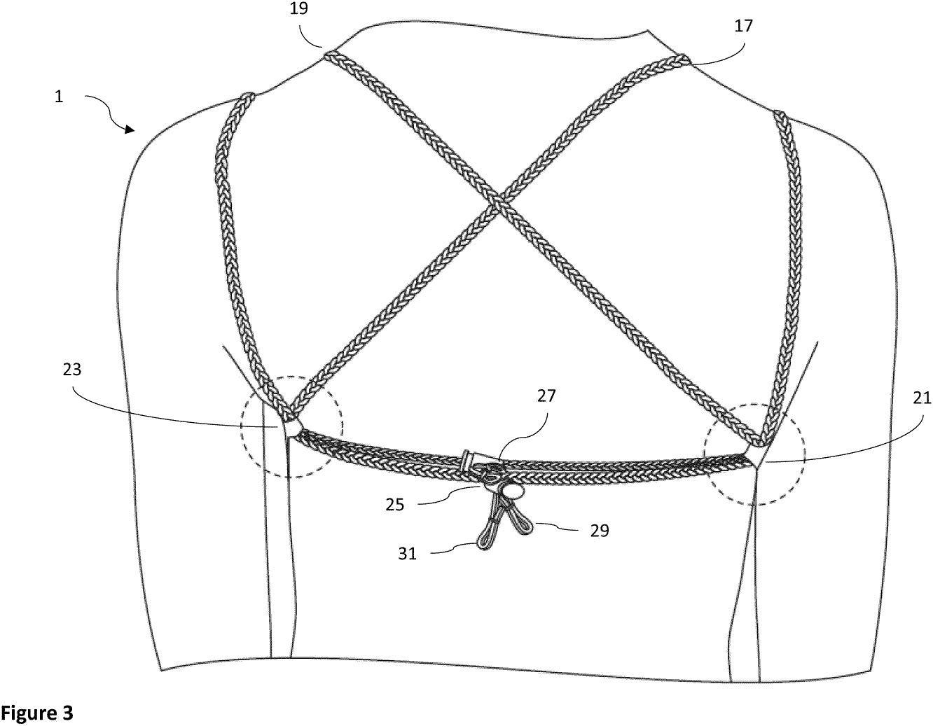

FIG. 3 shows a back view of one embodiment of a swimsuit, more specifically an alternate strap configuration, according to the present teachings.

The first strap 17 may have a first end 25 and a second end 29 opposite the first end. The second strap 19 may also have a first end 27 and a second end 31. Each end 25, 27, 29, 31 may have an attached eye loop. The eye loop may be dimensionally constructed and sized to pass through the loops 13, 15, 21, 23 of the swimsuit 1. Each eye loop may be an extension of the material used to form the straps 17, 19. It is understood that each eye loop may also be separately added to the ends 25, 27, 29, 31 of the straps 17, 19.

In one embodiment each eye loop may be ridged, or a stiffening member may be incorporated in, disposed on, or attached to each eye loop to provide structure to the eye loop that will not bend or flex out of shape when a user threads the eye loop and straps 17, 19 through the loops 13, 15, 21, 23. It is understood that the eye loops may be replaced with a plastic, hard rubber, vinyl, or other ridged object that can be used to assist threading the straps 17, 19 through the loops 13, 15, 21, 23.

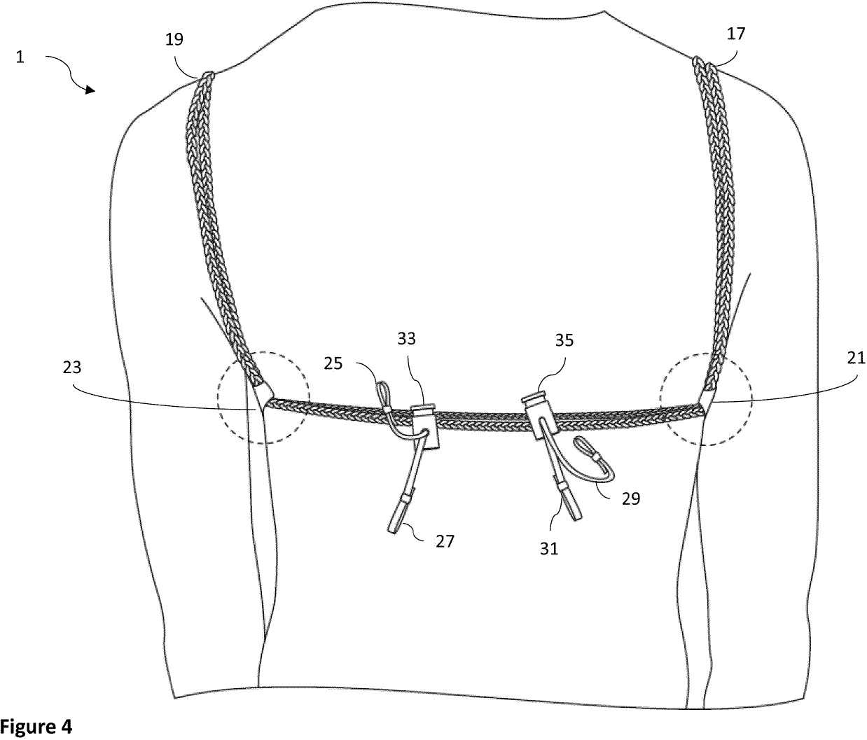

FIG. 4 shows a back view of one embodiment of a swimsuit, more specifically a further alternate strap configuration, according to the present teachings.

The swimsuit 1 may also have a first fastener 33 and a second fastener 35. The fasteners 33, 35 may be permanent or temporary fasteners. The fasteners 33, 35 may be a spring cord fastener, a clamp, glue, a knot, or any other means of securing two or more straps together.

The first fastener 33 may secure the first end 25 of the first strap 17 to the first end 27 of the second strap 19. In a preferred embodiment the first end 25 of the first strap 17 is releasably secured to the first end 27 of the second strap 19.

The second fastener 35 may secure the second end 29 of the first strap 17 to the second end 31 of the second strap 19. In a preferred embodiment the second end 27 of the first strap 17 is releasably secured to the second end 31 of the second strap 19.

In a preferred embodiment the straps 17, 19 may be easily adjusted by tightening or loosening the fasteners 33, 35. One or both of the first strap 17 and the second strap 19 may be replaced or interchanged with a new strap as necessary as the straps 17, 19 begin to deteriorate over time or if the straps 17, 19 break.

In a preferred embodiment the fasteners 33, 35 may be a spring cord fastener comprising a spring-biased fastener having an outer body including an opening and an outer body aperture formed through the outer body. The fasteners 33, 35 may also include an inner body shaped and sized to slide within the opening of the outer body where an inner body aperture is formed through the inner body. The inner body may also include a stopper formed adjacent a lower section of the inner body aperture to prevent the inner body from falling out of the opening of the outer body when the inner body is securely inserted within the outer body.

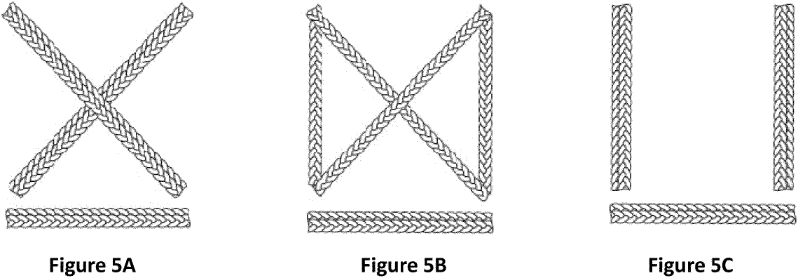

In one embodiment, shown in FIGS. 2 and 5A, the first end 25 of the first strap 17 and the second end 29 of the first strap may pass through the second side loop 23 and the first end 27 of the second strap 19 and the second end 31 of the second strap 19 may pass through the first side loop 21. The first end 25 of the first strap 17 may be releasably secured to the first end 27 of the second strap 19 and the second end 29 of the first strap 17 may be releasably secured to the second end 31 of the second strap 19. Alternatively, the first end 25 of the first strap 17 may be releasably secured to the second end 29 of the first strap 17 and the first end 27 of the second strap 19 may be releasably secured to the second end 31 of the second strap 19. The first strap 17 and the second strap 19 may form an X pattern across the wearer’s back.

In one embodiment, shown in FIGS. 3 and 5B, the first end 25 of the first strap 17 may pass through the second side loop 23, the second end 29 of the first strap 17 may pass through the first side loop 21, the first end 27 of the second strap 19 may pass through the first side loop 21, and the second end 31 of the second strap 19 may pass through the second side loop 23. The first end 25 of the first strap 17 may be releasably secured to the first end 27 of the second strap and the second end 29 of the first strap 17 may be releasably secured to the second end 31 of the second strap 19. The first strap 17 and the second strap 19 may form an X pattern bordered on the sides and bottom on the wearer’s back.

In one embodiment, shown in FIGS. 4 and 5C, the first end 25 of the first strap 17 and the second end 29 of the first strap may pass through the first side loop 21 and the first end 27 of the second strap 19 and the second end 31 of the second strap 19 may pass through the second side loop 23. The first end 25 of the first strap 17 may be releasably secured to the first end 27 of the second strap and the second end 29 of the first strap 17 may be releasably secured to the second end 31 of the second strap 19. The first strap 17 and the second strap 19 may form a squared U pattern on the wearer’s back.

In a preferred embodiment the swimsuit 1 may have a first strap 17 and a second strap 19. Having two straps 17, 19 may allow for faster and easier switching between the various strap configurations as described above. It is understood that while the preferred embodiment has a first strap 17 and a second strap 19, the straps 17, 19 may be replaced a single elongated strap. Instead of securing the straps 17, 19 at two points a single strap may be used and secured at one point. The single strap may pass through loops 13, 15, 21, 23 in the same manner as the first strap 17 and the second strap 19. Alternatively, it is understood that the straps 17, 19 may be replaced by a plurality of straps secured together end to end.

The strap may be multi-functional and depending on the length may serve a variety of purposes. For example, the same strap used with the swimsuit may also be used as a head band, google strap, or headband, although not limited thereto. Depending on the length of strap used, i.e., a single long strap or a plurality of smaller straps banded together, the strap may serve multiple purposes. By way of further example, from a manufacturing standpoint it may be advantageous to use multiple bands/straps of uniform size such that they may be used for different functions, e.g., using two goggle straps secured together to

In an alternate embodiment the swimsuit may be configured substantially similar to a bikini tube top. In this embodiment the swimsuit may have at least a first side loop and a second side loop and may not have any top loops. The swimsuit may have a single braided strap having a first end and a second end. The braided strap may be threaded through the first side loop and second side loop. The side loops may be size such that the braided strap is slidable through the loops when worn and not worn. The first end may be releasably secured to the second end.

While the present teachings have been described above in terms of specific embodiments, it is to be understood that they are not limited to these disclosed embodiments. Many modifications and other embodiments will come to mind to those skilled in the art to which this pertains, and which are intended to be and are covered by this disclosure. It is intended that the scope of the present teachings should be determined by proper interpretation and construction of the disclosure and its legal equivalents, as understood by those of skill in the art relying upon the disclosure in this specification and the attached drawings. In describing the invention, it will be understood that a number of techniques and steps are disclosed. Each of these has individual benefits and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification should be read with the understanding that such combinations are entirely within the scope of the invention.

What is claimed is:

1. A swimsuit customization system comprising:
a garment configured to cover at least a portion of a wearer’s torso, the garment having a first side loop and a first top loop on a left lateral side of the garment and a second side loop and a second top loop on a right lateral side of the garment;
a strap having a first end and a second end opposite the first end, the strap being removably inserted in the first side loop, the second side loop, the first top loop, and the second top loop; and
an arrangement defined by a position of the strap in the first side loop, the second side loop, the first top loop, and the second top loop and an order of the first side loop, the second side loop, the first top loop, and the second top loop which the strap extends through from the first end to the second end;
wherein the first end is connected to the second end.

2. The system of claim 1, further comprising a second strap and a second garment;
wherein the strap and the second strap are interchangeable, and the garment and the second garment are interchangeable.

3. The system of claim 1, wherein the strap is flat.

4. The system of claim 1, wherein the strap comprises a plurality of bands.

5. The system of claim 4, wherein each of the plurality of bands are flat.

6. The system of claim 4, where the plurality of bands includes three bands.

7. The system of claim 1, wherein the strap is made of nylon.

8. The system of claim 1, further comprising a fastener;
wherein the first end of the strap is connected to the second end of the strap by the fastener.

9. The system of claim 7, wherein the fastener is a spring cord lock.

10. The system of claim 1, further comprising an eye loop attached to each end of the strap.

11. The system of claim 1, wherein the garment is configured to cover the wearer’s anterior torso, genitalia, and buttock.

12. A swimsuit customization system comprising:
a garment configured to cover at least a portion of a wearer’s torso, the garment having a first side loop and a first top loop on a left lateral side of the garment and a second side loop and a second top loop on a right lateral side of the garment;
a first strap having a first end and a second end opposite the first end, the first strap being removably inserted in the first top loop and at least one of the first side loop and the second side loop;
a second strap having a first end and a second end opposite the first end, the second strap being removably inserted in the second top loop and at least one of the first side loop and the second side loop;
a plurality of arrangements defined by a position of the first strap in the first top loop, the first side loop and the second side loop, a position of the second strap in the second top loop, the first side loop and the second side loop, an order of the first top loop, the first side loop and the second side loop which the first strap extends through from the first end of the first strap to the second end of the first strap and an order of the second top loop, the first side loop and the second side loop which the second strap extends through from the first end of the second strap to the second end of the second strap;
wherein the position of the first strap and the position of the second strap are independent from each other.

13. The system of claim 12, further comprising a first fastener and a second fastener.

14. The system of claim 13, wherein first end of the first strap is connected to the first end of the second strap by the first fastener and the second end of the first strap is connected to the second end of the second strap by the second fastener.

15. The system of claim 13, wherein first end of the first strap is connected to the second end of the first strap by the first fastener and the first end of the second strap is connected to the second end of the second strap by the second fastener.

16. The system of claim 12, wherein a first arrangement is defined by the first end of the first strap and the second end of the first strap being inserted through the first side loop and the first end of the second strap and the second end of the second strap being inserted through the second side loop.

17. The system of claim 12, wherein a second arrangement is defined by the first end of the first strap and the second end of the first strap being inserted through the second side loop and the first end of the second strap and the second end of the second strap being inserted through the first side loop.

18. The system of claim 12, wherein a third arrangement is defined by the first end of the first strap and the first end of the second strap being inserted through the first side loop and the second end of the first strap and the second end of the second strap being inserted through the second side loop.

19. The swimsuit of claim 12, further comprising a third strap;
Wherein the third strap is interchangeable with the first strap and the second strap.

20. A swimsuit customization system comprising:
a garment configured to cover at least a portion of a wearer’s torso, the garment having a first side loop and a first top loop on a left lateral side of the garment and a second side loop and a second top loop on a right lateral side of the garment;
a first three bands having a flat shape braided together forming a first strap, the first strap having a first end and a second end opposite the first end;
a second three bands having a flat shape braided together forming a second strap having a first end and a second end opposite the first end;
an eye loop attached to each end of the first strap and each end of the second strap;
a first fastener and a second fastener, being spring cord locks, secure one of the first end of the first strap, the second end of the first strap, the first end of the second strap and the second end of the second strap to each other; and
a plurality of arrangements defined by a position of the first strap in the first top loop, the first side loop and the second side loop, a position of the second strap in the second top loop, the first side loop and the second side loop, an order of the first top loop, the first side loop and the second side loop which the first strap extends through from the first end of the first strap to the second end of the first strap and an order of the second top loop, the first side loop and the second side loop which the second strap extends through from the first end of the second strap to the second end of the second strap;
wherein the position of the first strap and the position of the second strap are independent from each other.
